(19) United States
(12) Patent Application Publication
(10) Pub. No.: US 2007/0120392 A1
(43) Pub. Date: May 31, 2007

(54) Mounting device for use with a thin walled structure

(76) Inventor: David Gary Wolfinger, Sydney (AU)

Correspondence Address: David Wolfinger, PO Box 1995, Sydney, 2001, AU

(21) Appl. No.: 10/573,182

(22) PCT Filed: Sep. 14, 2004
(86) PCT No.: PCT/AU04/01247

§ 371 Date: Dec. 28, 2006

(30) Foreign Application Priority Data
Sep. 24, 2003 (AU) 2003905229

(51) Int. Cl. B60P 7/02

(52) U.S. Cl. 296/100.17

(57) ABSTRACT

A mounting device (10) for mounting accessories to a wall (34) of a thin walled structure such as a tent or a sheet of glass. Device (10) includes first member (12) having first engagement surface (18); a mounting portion suitable for mounting an accessory such as a light fitting; and second member (14) having second engagement surface (22); the first and second members (12, 14) being magnetically attracted to one another so that when applied on opposite sides of wall (34), first and second surfaces (18, 22) frictionally engage the part of wall (34) between them and retain mounting device (10) on wall (34). First and second surfaces (18, 22) have surrounding edges which are profiled to allow device (10) to slide smoothly on wall (34) when device (10) is forcibly moved in relation to wall (34).

### TECHNICAL FIELD

This invention relates to a mounting device for use with a thin walled structure.

### BACKGROUND OF THE INVENTION

In a living area it is often desirable to mount accessories such as lamps and mirrors on the walls or ceiling. Mounting a mirror on a wall makes it easier to look into. Mounting a lamp on a ceiling improves the effectiveness of the lamp to illuminate the living area. Typically, these accessories are mounted by fixing screws or the like into the walls or ceiling of the living area. However, if the living area is thin walled, such as is the case with a tent, then fixing screws cannot be used because the walls are too thin to retain the fixing screws.

Accessories can be mounted in a tent by hanging them from an internal support frame of the tent, over which the tent fabric is secured. However, this limits the positions at which one can mount an accessory. Further, the support frame of many modern tents is external to the tent cover and it is not possible to use the support frame to hang items inside the tent.

### SUMMARY OF THE INVENTION

In a first aspect the present invention provides a mounting device for mounting accessories to the wall of a thin walled structure, the mounting device including: a first member including a first engagement surface and a mounting portion suitable for mounting an accessory and; a second member including a second engagement surface; the first and second members being magnetically attracted to one another so that when positioned on opposite sides of the thin wall the first and second engagement surfaces frictionally engage the part of the wall disposed between them and thereby retain the mounting device on the wall; and wherein the first and second engagement surfaces have surrounding edges which are profiled to allow the device to slide smoothly on the thin wall when the device is forcibly moved in relation to the thin wall.

The edges may be bevelled.

Alternatively, the edges may be curved.

The first and second engagement surfaces may be flat.

The first and second engagement surfaces may be substantially circular.

Both the first and second members may include a permanent magnet.

The permanent magnet may be retained in a member by a cup which engages the member with a waterproof seal and forms part of an engagement surface.

The mounting portion may be a hook.

### BRIEF DESCRIPTION OF THE DRAWINGS

An embodiment of the present invention will now be described, by way of example only, with reference to the accompanying drawings, in which:

FIG. 1 is an isometric view of a first member of an embodiment of a mounting device according to the present invention;

FIG. 2 is a side view of the first member of FIG. 1;

FIG. 3 is a top view of the first member of FIG. 1;

FIG. 4 is a cross section view along the line A-A;

FIG. 5 is a detail view of the area B in FIG. 4;

FIG. 6 is a cross section view along line C-C;

FIG. 7 is a cross section view along the line D-D;

FIG. 8 is a top view of a second member of an embodiment of a mounting device for use with the first member illustrated in FIG. 1;

FIG. 9 is a cross section view along the line E-E of FIG. 8;

FIG. 10 is a detailed view of the area F of FIG. 9;

FIG. 11 is a side view of an embodiment of a mounting device according to the invention including the first and second members shown in FIGS. 1 and 9;

FIG. 12 is a top view of the mounting device of FIG. 11;

FIG. 13 is a cross section view along the line G-G; and

FIG. 14 is a detailed view of the area H of FIG. 13.

### DETAILED DESCRIPTION OF THE PREFERRED EMBODIMENT

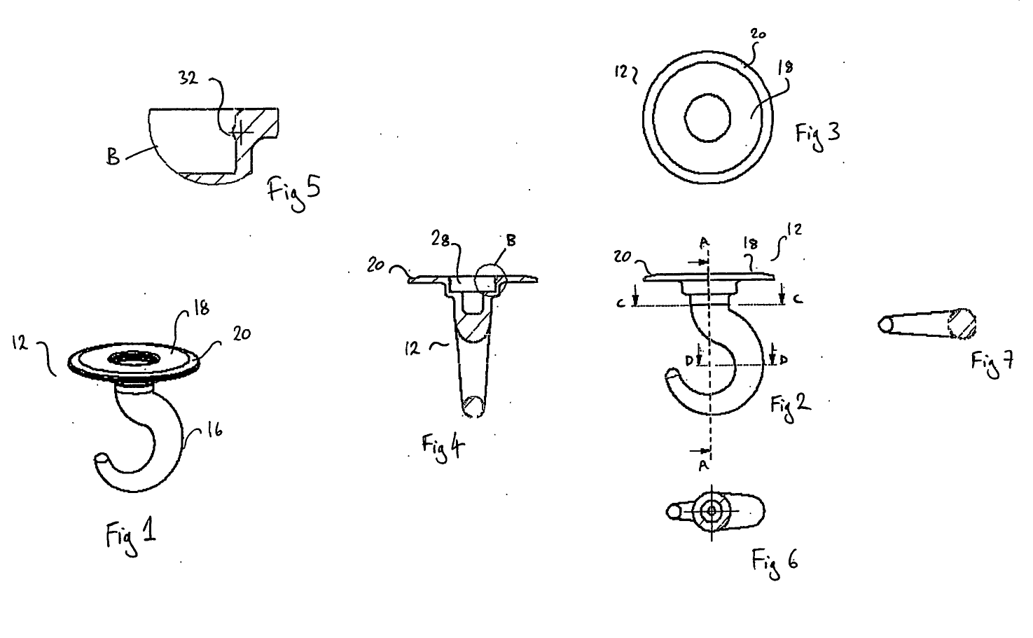

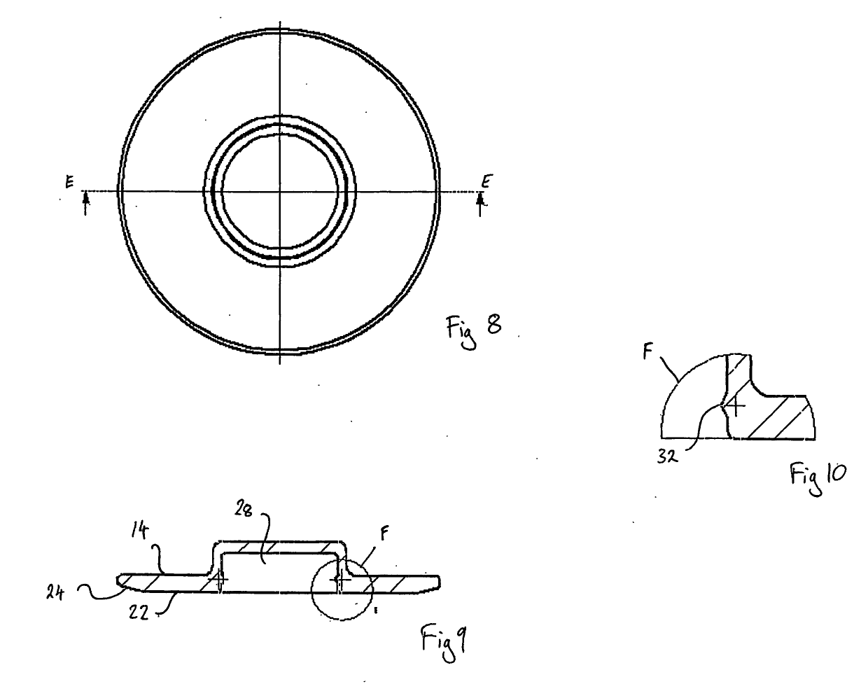

Referring to FIGS. 1 to 7, a first member 12 of a mounting device 10 (see FIG. 11) for mounting accessories to the wall of a thin walled structure is shown. The first member 12 in this embodiment includes a mounting portion in the form of hook 16 suitable for mounting accessories and a flat and circular engagement surface 18. Engagement surface 18 has a surrounding bevelled edge 20.

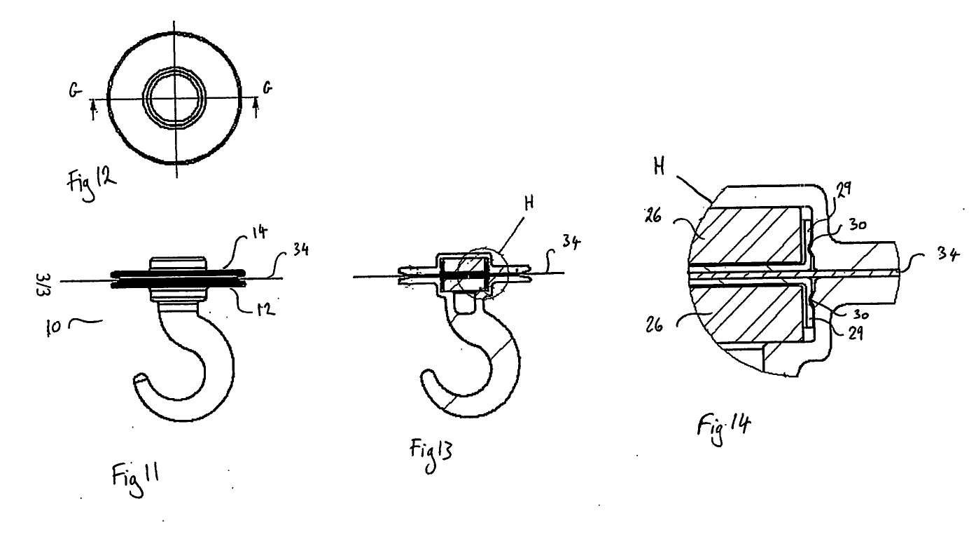

Referring to FIGS. 8 to 10, a second member 14 is shown for use with the first member 12. Similarly to the first member, the second member includes a flat circular engagement surface 22 and a surrounding bevelled edge 24.

Referring to FIGS. 13 and 14, both first and second members include permanent magnets 26. Each magnet is retained in a recess 28 by cup 29. Cup 29 and first and second members 12, 14 are moulded from plastic and cup 29 includes an annular recess 30 that engages with annular detent 32 to retain the cup 29 and permanent magnet 26 in recess 28 of either the first or second member 12,14. At the same time, the engagement of annular recess 30 with annular detent 30 forms a water tight seal between cup and the member which serves to protect permanent magnet 26 from water damage. The back surface of cup 29 forms a part of the engagement surface of the member in which it is retained.

A method of use of mounting device 10 will now be explained with reference to hanging a mirror inside a tent. At the fabric door of the tent, the first member 12 is positioned with engagement surface 18 against the inside surface of the tent door. The second member 14 is positioned with engagement surface 22 against the outside surface of the tent door and is brought to the same position on the door as the first member. Magnetic attraction between first and second members causes the engagement surfaces to frictionally engage the fabric of the tent door between the first and second members and retain mounting device 10 on the door of the tent. By grasping hook 16 and forcibly moving mounting device 10 it can be brought to a position on the tent where it is desired to hang the mirror. The second member 14 is follows the first member on the outside of the tent by being magnetically attracted to the first member. When in a desired position, the mirror can be mounted by hanging it from hook 16. FIGS. 11, 13 and 14 show mounting device 10 in position on a tent wall 34.

Both first and second members 12, 14 include profiled edges in the form of bevelled edges 20,24. When the mounting device 10 is being forcibly moved with respect to the tent wall, the profiled edges help the device to slide smoothly along the wall. Further, the profiled edges assist the device to slide over obstructions on the wall such as seams in the tent fabric. Without profiled edges, the mounting device could even tear the fabric of a tent.

It will be appreciated that, instead of using two permanent magnets 26, only one magnet can be used with a slug of ferrous metal taking the place of the magnet in the corresponding other member. This may reduce the attractive force between the first and second members but will suffice as long as sufficient magnetic attraction exists between the members to retain them on the wall under the weight of the accessory that they are to mount to the wall.

The engagement surfaces 18, 22 are smooth to avoid damage to a wall they are retained upon, such as a tent wall.

The first or second member may be made luminous so that they are more easily seen. This assists with using the mounting device at night or in dark places.

Whilst the mounting portion of the first member has been described as a hook, other similar mounting arrangements such as a clip can be used. Alternatively, the first member may be provided with a slot into which a corresponding part of a hook or an accessory such as a torch or lamp or mirror or the like may be inserted to be retained in the first member.

The first and second engagement surfaces have been described as round. Engagement surfaces that are square, oval or otherwise shaped may be used.

Whilst this invention has been described with reference to use in conjunction with a tent, it has application to mount accessories to the walls of other thin walled structures including flat glass and other fabric panels. These include but are not limited to greenhouses and display stands.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

The claims defining the invention are as follows:

1. A mounting device for mounting accessories to a wall of a thin walled structure, the mounting device including:
a first member including a first engagement surface and a mounting portion suitable for mounting an accessory;
a second member including a second engagement surface;
the first and second members being magnetically attracted to one another so that when positioned on opposite sides of the thin wall the first and second engagement surfaces frictionally engage the part of the wall disposed between them and thereby retain the mounting device on the wall; and wherein the first and second engagement surfaces have surrounding edges which are profiled to allow the device to slide smoothly on the thin wall when the device is forcibly moved in relation to the thin wall.

2. A mounting device according to claim 1 wherein the edges are bevelled.

3. A mounting device according to claim 1 wherein the edges are curved.

4. A mounting device according to any one of the preceding claims wherein the first and second engagement surfaces are flat.

5. A mounting device according to any one of the preceding claims wherein the first and second engagement surfaces are substantially circular.

6. A mounting device according to any one of the preceding claims wherein both the first and second members include a permanent magnet.

7. A mounting device according to any one of the preceding claims wherein the permanent magnet is retained in a member by a cup which engages the member with a waterproof seal.

8. A mounting device according to claim 7 wherein the cup forms part of the engagement surface.

9. A mounting device according to any one of the preceding claims wherein the mounting portion is a hook.

10. A mounting device substantially as described herein with reference to the accompanying drawings.
